(19) United States
(12) Patent Application Publication
(10) Pub. No.: US 2020/0050766 A1
(43) Pub. Date: Feb. 13, 2020

(54) METHOD AND DATA PROCESSING SYSTEM FOR REMOTELY DETECTING TAMPERING OF A MACHINE LEARNING MODEL

(71) Applicant: NXP B.V., Eindhoven (NL)

(72) Inventor: JOPPE WILLEM BOS, Wijgmaal (BE)

(21) Appl. No.: 16/058,094

(22) Filed: Aug. 8, 2018

(51) Int. Cl. G06F 21/57; G06N 99/00; G06F 21/52

(52) U.S. Cl. CPC G06F 21/57; G06F 2221/033; G06F 21/52; G06N 99/005

(57) ABSTRACT

A method and data processing system for detecting tampering of a machine learning model is provided. The method includes training a machine learning model. During a training operating period, a plurality of input values is provided to the machine learning model. In response to a predetermined invalid input value, the machine learning model is trained that a predetermined output value will be expected. The model is verified that it has not been tampered with by inputting the predetermined invalid input value during an inference operating period. If the expected output value is provided by the machine learning model in response to the predetermined input value, then the machine learning model has not been tampered with. If the expected output value is not provided, then the machine learning model has been tampered with. The method may be implemented using the data processing system.

### BACKGROUND

### Field

This disclosure relates generally to machine learning, and more particularly, to a method and data processing system for remotely detecting tampering of a machine learning model.

### Related Art

Machine learning is becoming more widely used in many of today's applications, such as applications involving forecasting and classification. Generally, a machine learning algorithm is trained, at least partly, before it is used. Training data is used for training a machine learning algorithm. Machine learning models may be classified by how they are trained. Supervised learning, unsupervised learning, semi-supervised learning, and reinforcement learning are examples of training techniques. The effectiveness of the machine learning model is influenced by its accuracy, execution time, storage requirements, and the quality of the training data. The expertise, time, and expense required for compiling a representative training set of data, labelling the data results in the training data, and the machine learning model obtained from the training data are valuable assets.

Protecting a machine learning model from attacks has become a problem. Model extraction is an attack that results in a near identical copy of a machine learning model by inputting valid queries to the model and compiling the resulting output. Once an attacker has access, the machine learning model can be relatively easily copied. Once an attacker has copied the model, it can be illegitimately monetized. Illegitimate tampering with a machine learning model has become another problem. Tampering may be used by an attacker to illegitimately change what a machine learning model will output in response to certain input values. Given local access to the model, detecting tampering is relatively easy. However, if the machine learning model is deployed remotely, such as in the cloud or in a black box, detecting tampering is more difficult.

Therefore, a need exists for a way to remotely detect tampering of a machine learning model.

### BRIEF DESCRIPTION OF THE DRAWINGS

The present invention is illustrated by way of example and is not limited by the accompanying figures, in which like references indicate similar elements. Elements in the figures are illustrated for simplicity and clarity and have not necessarily been drawn to scale.

FIG. 1 illustrates an internet of things (IoT) edge node and an IoT device in accordance with an embodiment.

FIG. 2 illustrates a data processing system for use in either the IoT edge node or IoT device in accordance with an embodiment.

FIG. 3 illustrates a method for detecting tampering of a machine learning model in accordance with an embodiment.

### DETAILED DESCRIPTION

Generally, there is provided, a method for remotely detecting tampering of a machine learning model. A machine learning model is trained using a supervised learning algorithm during a training period. In one embodiment, one or more invalid input values is provided to train the machine learning model what the expected output value will be. The one or more input values are invalid because they have at least one criteria, or parameter, that is outside of a predetermined range for the criteria for a valid input value. The one or more invalid input values may be a random bit-map such as noise. To remotely verify the integrity of the model, or to remotely determine if the model has been tampered with, this specifically crafted invalid input value is input to the model during an inference operating period. The inference operating period occurs after the model is trained and the model is in use in an application. A model that has been cloned by extraction, or a model that has been tampered with, will not have been trained with the invalid input value, and will not respond in the same way to the special invalid input value. Therefore, if the output value provided by the model is the expected output value that the model was trained to provide in response to the invalid input value, then the model has probably not been tampered with.

By training the model with an invalid input value, the integrity of a machine learning model can be verified remotely, without requiring direct local access to the model. The use of an invalid input value makes it more unlikely that an attacker will be able to guess or find the correct invalid input value that was used in the training phase.

In accordance with an embodiment, there is provided, a method including: training a machine learning model during a training operating period by providing a predetermined input value to the machine learning model and directing the machine learning model that a predetermined output value will be expected in response to the predetermined input value; and verifying that the machine learning model has not been tampered with by inputting the predetermined input value during an inference operating period, wherein if the expected output value is output, then the machine learning model has not been tampered with, and wherein if the expected output value is not output, then the machine learning model has been tampered with. The predetermined input value may be characterized as being an invalid value. Each of the plurality of input values may include a predetermined parameter, wherein the predetermined parameter is within a predetermined range, and wherein the predetermined input value includes the predetermined parameter outside the predetermined range. Only black box access may be provided to the machine learning model. The predetermined input value may be a secret input value. The predetermined input value may be randomly selected. The predetermined input value may be one of a plurality of input values for determining if the machine learning model has been tampered with. The method may be implemented in an internet of things (IoT) node. The method may further include determining that the tampered with machine learning model has been illegitimately modified.

In another embodiment, there is provided, a method for remotely detecting tampering of a machine learning model, the method including: training a machine learning model during a training operating period by providing a plurality of input values to the machine learning model; providing an invalid input value to the machine learning model, and in response to the invalid input value, the machine learning model is trained that a predetermined output value will be expected; and verifying that the model has not been tampered with by inputting the invalid input value during an inference operating period, wherein if the expected output value is provided by the machine learning model, then the machine learning model has not been tampered with, and wherein if the expected output value is not provided, then the machine learning model has been tampered with. The method may further include establishing a predetermined range of values for a common parameter of each of the plurality of input values, wherein the common parameter of the invalid input value may be outside the predetermined range. The invalid input value may be randomly selected. The invalid input value may be one of a plurality of invalid input values provided to the machine learning model. The method may be implemented in an internet of things (IoT) node. The invalid input value may be a secret value.

In another embodiment, there is provided, a data processing system including: a memory for storing a machine learning model; and a processor for implementing a machine learning training algorithm to train the machine learning model using training data, wherein the training data includes a plurality of input values, wherein during training of the machine learning model, the machine learning model is trained to output an expected output value in response to receiving a predetermined input value, and wherein during inference operation of the machine learning model, the predetermined input value is provided to the machine learning model to determine if the machine learning model has been illegitimately tampered with. The predetermined input value may be characterized as being an invalid input value. Each of the plurality of input values may include a parameter within a predetermined range, and wherein the parameter of invalid input value is outside the predetermined range. The data processing system may be part of an internet of things (IoT) node. Only black box access may be provided to the machine learning model.

Machine learning algorithms may be used in many different applications, such as prediction algorithms and classification algorithms. Machine learning models learn a function which correctly maps a given input value to an output value using training data. The learned function can be used to categorize new data. In one embodiment, the set of input values are considered valid input values if they make sense for the use-case, for example, photos or pictures of dogs and cats. An invalid input value is a value that does not make sense for a use-case, such as a picture of an automobile when the valid input values include only dogs and cats. In many use-cases, or applications, the input values to the machine learning model do not make sense for the use-case, and the model will return a best prediction that is non-sensical for invalid input values. In accordance with an embodiment, a set of invalid input values can be selected randomly, or may be carefully selected, and used to train the model to provide a predetermined output value. An example of an invalid input value may be a randomly generated bit-map, or noise. In another example, a patient may be likely to suffer from a certain disease based on a range of personal information, for example, blood pressure. An example of invalid input data would be personal characteristics which are impossible, such as weight over a certain amount, a negative weight, or a blood pressure value that is much higher than is possible for a person. Just like for the valid input values, the machine learning model may be trained to provide a predetermined output value in response to one or more invalid input values. Using the invalid input values along with the valid input values ensures that the machine learning model works as intended for the valid input values, while also providing the preselected output values for the invalid input values.

A goal of model extraction, or model cloning, is to extract the functionality of the machine learning model as accurately as possible by providing queries to the machine learning model and storing the returned outputs. The input/output pairs of data can be used to train another machine learning model which in terms of functionality is close to the original model. Without knowledge of the selected input values, it is unlikely that an adversary, or attacker, will ask exactly the same queries used to train the original model. Hence, the cloned model is likely to work correctly for the original input values. Therefore, during the inference phase, when provided with the special invalid input values, the cloned model will provide different output values than the original model. When only remote access is available to the model, because the model may be in the cloud or in a black box, the owner of the model can check if a suspected model is the original model or has been tampered with by inputting the invalid input values and checking if the correct output value is provided.

The same remote verification method can be used to check the integrity of the machine learning model. For example, the weights used in a neural network define the behavior of a model and are proprietary information of the model owner. Tampering with the weights may significantly alter the output of the machine learning model. A model which uses an altered internal state will produce an output which is with overwhelming probability not in the set of required output values. Therefore, a person with knowledge of the predetermined invalid input value can efficiently verify if the model has been tampered with, or not, even without direct access to the model.

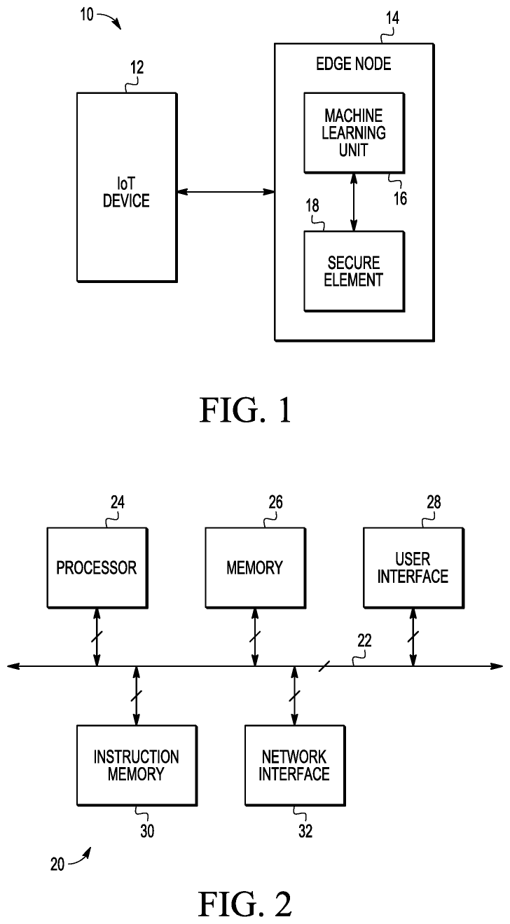

FIG. 1 illustrates a portion of a system 10 having an IoT device 12 and an IoT edge node 14 in accordance with an embodiment. The IoT device 12 and edge node 14 may each be implemented on one or more integrated circuits. In FIG. 1, the IoT device 12 is bi-directionally connected to edge node 14. The IoT device 12 produces data that is sent to edge node 14. Edge node 14 includes machine learning unit 16 and secure element 18. A neural network architecture may be implemented in machine learning unit 16 as an implementation of a machine learning model. Secure element 18 is tamper resistant and may be used to store an application for operating in machine learning unit 16. Secure element 18 may also include a processor and memory. The IoT device 12 may also have a secure element as implemented and described for edge node 14. System 10 may include other portions (not shown) that would be capable of implementing the machine learning unit and secure element as described.

FIG. 2 illustrates data processing system 20 for use in either IoT edge node 14 or IoT device 12 in accordance with an embodiment. Data processing system 20 may be implemented on one or more integrated circuits and may be used to implement either or both of machine learning unit 16 and secure element 18. Data processing system 20 includes bus 22. Connected to bus 22 is processor 24, memory 26, user interface 28, instruction memory 30, and network interface 32. Processor 24 may be any hardware device capable of executing instructions stored in memory 26 or instruction memory 30. Processor 24 may be, for example, a microprocessor, field programmable gate array (FPGA), application-specific integrated circuit (ASIC), or similar devices. The processor may be in the secure hardware element and may be tamper resistant.

Memory 26 may be any kind of memory, such as for example, L1, L2, or L3 cache or system memory. Memory 26 may include volatile memory such as static random-access memory (SRAM) or dynamic RAM (DRAM), or may include non-volatile memory such as flash memory, read only memory (ROM), or other volatile or non-volatile memory. Also, memory 26 may be in a secure hardware element.

User interface 28 may be connected to one or more devices for enabling communication with a user such as an administrator. For example, user interface 28 may be enabled for coupling to a display, a mouse, a keyboard, or other input/output device. Network interface 32 may include one or more devices for enabling communication with other hardware devices. For example, network interface 32 may include, or be coupled to, a network interface card (NIC) configured to communicate according to the Ethernet protocol. Also, network interface 32 may implement a TCP/IP stack for communication according to the TCP/IP protocols. Various other hardware or configurations for communicating are available for communicating.

Instruction memory 30 may include one or more machine-readable storage media for storing instructions for execution by processor 24. In other embodiments, memory 30 may also store data upon which processor 24 may operate. Memory 26 may store, for example, a machine learning model, or encryption, decryption, or verification applications. Memory 30 may be in the secure hardware element and be tamper resistant.

A memory of data processing system 20, such as memory 26, may be used to store a machine learning model in accordance with an embodiment, where an invalid input value has been used to train the model to provide a predetermined output value as described herein. Then if an attacker tampers with the stored model, it is possible to remotely detect the tampering by inputting the invalid input value the original model was previously trained with, and observing the returned output value. Data processing system 20, in combination with the machine learning model and the machine learning algorithm improve the functionality of an application, such as an IoT edge node illustrated in FIG. 1, by allowing the verification of the integrity of the machine learning model as described herein.

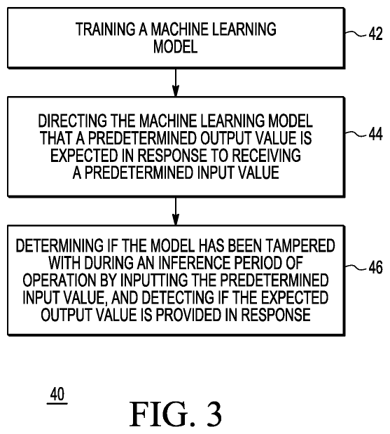

FIG. 3 illustrates method 40 for remotely detecting tampering of a machine learning model in accordance with an embodiment. Machine learning models may be valuable assets. The ability to make an almost identical copy of a machine learning model by simple remote queries to the model is a growing problem for the owners of models. Also, tampering with the internal functionality of the machine learning models can cause incorrect output values with potentially harmful effects. Method 40 provides a method to detect if an attacker has tampered with a machine learning model. Method 40 may be implemented, for example, in the data processing system 20 of FIG. 2. Method 40 begins at step 42. At step 42, a machine learning model is trained by providing training data having a plurality of input values to the machine learning model. A machine learning algorithm directs how the machine learning model is trained on the training data. In one embodiment, the machine learning model is trained using supervised learning during a training operating period. As part of the plurality of input values, a predetermined input value may be provided. At step 44, the machine learning model is directed that a predetermined output value is expected in response to receiving the predetermined input value. The predetermined input value will be used during the inference operating period to determine if the machine learning model has been tampered with. Generally, the plurality of input values is a plurality of valid input values. Valid input values have certain common characteristics, or parameters. For example, the plurality of input values may all be photos of dogs or cats. In another example, the common parameter of the plurality of valid input values may be within a predetermined range of values. For example, the common parameter may be temperature and the range may be between a lower temperature limit and an upper temperature limit. A machine learning model is generally only trained using valid input values. In accordance with an embodiment, a predetermined input value may be an invalid input value. An invalid input value is invalid because a parameter or criteria of the invalid input value is outside a range of values as compared to a plurality of valid input values of the training data. In one embodiment, the invalid input value is a random bit map, for example, noise. In another embodiment, the invalid input value may be a plurality of invalid input values. Also, the invalid input value may be maintained as a secret value. At step 46, it is determined if the machine learning model has been tampered with during inference operation by inputting the predetermined input value, which may be an invalid input value, and detecting if the expected output value is provided in response. If the expected output value is provided, then the machine learning model has not been tampered with. If the expected output value is not provided, then the machine learning model has been tampered with. The use of a secret invalid input value as a test for tampering makes it unlikely an attacker has trained a tampered with machine learning model the expected output value.

Various embodiments, or portions of the embodiments, may be implemented in hardware or as instructions on a non-transitory machine-readable storage medium including any mechanism for storing information in a form readable by a machine, such as a personal computer, laptop computer, file server, smart phone, or other computing device. The non-transitory machine-readable storage medium may include volatile and non-volatile memories such as read only memory (ROM), random access memory (RAM), magnetic disk storage media, optical storage medium, NVM, and the like. The non-transitory machine-readable storage medium excludes transitory signals.

Although the invention is described herein with reference to specific embodiments, various modifications and changes can be made without departing from the scope of the present invention as set forth in the claims below. Accordingly, the specification and figures are to be regarded in an illustrative rather than a restrictive sense, and all such modifications are intended to be included within the scope of the present invention. Any benefits, advantages, or solutions to problems that are described herein with regard to specific embodiments are not intended to be construed as a critical, required, or essential feature or element of any or all the claims.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

What is claimed is:

1. A method comprising:
training a machine learning model during a training operating period by providing a predetermined input value to the machine learning model and directing the machine learning model that a predetermined output value will be expected in response to the predetermined input value; and
verifying that the machine learning model has not been tampered with by inputting the predetermined input value during an inference operating period, wherein if the expected output value is output, then the machine learning model has not been tampered with, and wherein if the expected output value is not output, then the machine learning model has been tampered with.

2. The method of claim 1, wherein the predetermined input value is characterized as being an invalid value.

3. The method of claim 2, wherein each of the plurality of input values includes a predetermined parameter, wherein the predetermined parameter is within a predetermined range, and wherein the predetermined input value includes the predetermined parameter outside the predetermined range.

4. The method of claim 1, wherein only black box access is provided to the machine learning model.

5. The method of claim 1, wherein the predetermined input value is a secret input value.

6. The method of claim 1, wherein the predetermined input value is randomly selected.

7. The method of claim 1, wherein the predetermined input value is one of a plurality of input values for determining if the machine learning model has been tampered with.

8. The method of claim 1, wherein the method is implemented in an internet of things (IoT) node.

9. The method of claim 1, further comprising determining that the tampered with machine learning model has been illegitimately modified.

10. A method for remotely detecting tampering of a machine learning model, the method comprising:
training a machine learning model during a training operating period by providing a plurality of input values to the machine learning model;
providing an invalid input value to the machine learning model, and in response to the invalid input value, the machine learning model is trained that a predetermined output value will be expected; and
verifying that the model has not been tampered with by inputting the invalid input value during an inference operating period, wherein if the expected output value is provided by the machine learning model, then the machine learning model has not been tampered with, and wherein if the expected output value is not provided, then the machine learning model has been tampered with.

11. The method of claim 10, further comprising establishing a predetermined range of values for a common parameter of each of the plurality of input values, wherein the common parameter of the invalid input value is outside the predetermined range.

12. The method of claim 10, wherein the invalid input value is randomly selected.

13. The method of claim 10, wherein the invalid input value is one of a plurality of invalid input values provided to the machine learning model.

14. The method of claim 10, wherein the method is implemented in an internet of things (IoT) node.

15. The method of claim 10, wherein the invalid input value is a secret value.

16. A data processing system comprising:
a memory for storing a machine learning model; and
a processor for implementing a machine learning training algorithm to train the machine learning model using training data, wherein the training data includes a plurality of input values, wherein during training of the machine learning model, the machine learning model is trained to output an expected output value in response to receiving a predetermined input value, and wherein during inference operation of the machine learning model, the predetermined input value is provided to the machine learning model to determine if the machine learning model has been illegitimately tampered with.

17. The data processing system of claim 16, wherein the predetermined input value is characterized as being an invalid input value.

18. The data processing system of claim 17, wherein each of the plurality of input values includes a parameter within a predetermined range, and wherein the parameter of invalid input value is outside the predetermined range.

19. The data processing system of claim 16, wherein the data processing system is part of an internet of things (IoT) node.

20. The data processing system of claim 16, wherein only black box access is provided to the machine learning model.
